(19) United States
(12) Patent Application Publication
(10) Pub. No.: US 2004/0224555 A1
(43) Pub. Date: Nov. 11, 2004

(54) Automotive flatwire connector

(75) Inventors: Harvinder Singh, Shelby Twp., MI (US); Prasanna Ramsagar, Southfield, MI (US)

Correspondence Address: Michael N. Spink, Esq., BRINKS HOFER GILSON & LIONE, P.O. Box 10395, Chicago, IL, 60610, US

(73) Assignee: Visteon Global Technologies, Inc.

(21) Appl. No.: 10/435,729

(22) Filed: May 8, 2003

(51) Int. Cl. H01R 12/24

(52) U.S. Cl. 439/495

(57) ABSTRACT

A flatwire connector suitable for the automotive environment is provided. The connector generally includes a male connector having a housing receiving the flatwire and a female connector having a housing structured to receive the male connector. The male connector has surfaces which firmly engage the upper and lower surfaces of the flatwire to provide mechanical support thereto. Additionally, a spring-loaded shield is provided which automatically covers the exposed conductive elements of the flatwire protecting them from the environment. A primary lock is formed which allows simple mating of the male and female connectors while requiring a minimal mating or insertion force. Finally, the unique structure of the cover and its slidable locking member provide a simple to use, but secure and protective secondary locking feature to the connector.

### FIELD OF THE INVENTION

The present invention relates generally to connectors for flatwire, and more particularly relates to flatwire connectors suitable for use in harsh environments.

### BACKGROUND OF THE INVENTION

Connectors for flatwire have been used in consumer electronics applications for a long time. As used herein, flatwire refers generally to flat cabling, such as flat flexible cable (FFC) and flat printed cable (FPC), as well as ribbon cable. The use of flatwire is often ideal because of the flatwire's low profile and ability to adapt to the contour of a supporting structure. In an electronic system, the flatwire is typically connected to other components such as printed circuit boards, flexible circuit boards, other flatwire segments, and other electronic devices. Accordingly, the use of connectors which adapt the flatwire for connection to these other components have been developed for a variety of applications.

Unfortunately, the applicability of flatwire connectors in the automotive environment is limited. Namely, the harshness of the automotive environment prevents the use of flatwire connectors in many situations. Mechanical vibrations and forces require that the flatwire connector remains physically and electronically connected at all times under harsh conditions, as well as provide the necessary structural support to the flatwire itself. Nonetheless, the flatwire connections must be easy to use and have low mating forces (i.e., insertion and friction forces in the interface area).

The harsh automotive environment thus puts many requirements on the flatwire connector which are often conflicting. The flatwire connector must also provide protection from physical intrusion when the flatwire connector is both connected or disconnected. Accordingly, there exists a need to provide a flatwire connector which addresses the needs of an automotive application, i.e., easy to use with low mating forces, while providing physical protection from the harsh automotive environment to ensure a durable and reliable electric connection.

### BRIEF SUMMARY OF THE INVENTION

One embodiment of the present invention provides a connector for flatwire that has exposed conductive elements. The connector generally includes a male connector having a housing receiving the flatwire and a female connector having a housing structured to receive the male connector. A cover is pivotally attached to the female connector housing and is operable between an open position and a closed position. A primary lock is defined by a deflectable tab formed on the male connector housing for engaging the female connector housing. A secondary lock is defined by a locking member slidable relative to the male connector housing. The locking member has a projection positioned to extend into an elongated groove formed in the male connector housing. The locking member is operable to selectively position the projection within the elongated groove between a locked position and an unlocked position.

According to more detailed aspects, the elongated groove extends at least partially vertically. Preferably, the locked position of the locking member and its projection is vertically below the unlocked position. In this way, the cover in its closed position, in conjunction with the locking member in its locked position, provides a predetermined normal force on the terminals of the female connector which engage the exposed conductive elements of the flatwire housed by the male connector. Preferably, the secondary lock is further defined by a deflectable flap formed on the locking member which is positioned to engage a recess formed on the cover when the locking member is in the locked position. Depressing a second portion of the deflectable flap allows the locking member to move to the unlocked position for disconnection of the flatwire connector.

Another embodiment of the present invention provides a connector for flatwire having exposed conductive elements. The connector generally includes a male connector having a housing receiving the flatwire to present the conductive elements. A female connector includes a housing structured to receive the male connector and includes terminals positioned to contact the conductive elements for electrically connecting the flatwire to an electronic component. A primary lock is defined by a deflectable tab formed on the male connector housing for engaging the female connector housing. A shield is slidably disposed within the male connector housing. The shield is operable between an extended position covering the conductive elements and a retracted position revealing the conductive elements.

According to more detailed aspects, the shield is preferably biased to the extended position. Typically, the female connector engages the shield and moves the shield between the extended and retracted positions when the male and female connectors are mated and unmated, respectively. Preferably, the male connector housing includes an upper housing and a lower housing sandwiching the flatwire. In this way, an upper surface of the flatwire is directly supported by the upper housing and a lower surface of the flatwire is directly supported by the lower housing. The shield may be integrally formed into the male connector housing, and preferably the upper housing where the flatwire includes an upper surface having the exposed conductors. The shield may also be formed with a separate shield housing which is then attached to the male connector housing.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of an embodiment of a flatwire connector constructed in accordance with the teaching of the present invention;

FIG. 2 is an exploded view of the flatwire connector depicted in FIG. 1;

FIG. 3 is a perspective view a bottom housing portion of the male connector housing;

FIG. 4 is a perspective view, taken from the bottom, of a lower housing portion of the male connector housing;

FIG. 5 is a perspective view of the male connector housing;

FIG. 6a-6c depict an alternate embodiment of a shield assembly for application to the male connector housing;

FIG. 7 is a perspective view of the male connector attached to the female connector housing;

FIG. 8 is a perspective view similar to FIG. 7, but having the cover attached to the female connector housing;

FIG. 9 is a perspective view, taken from the bottom, of the cover shown in FIG. 8; and

FIG. 10 is a side view of the male connector mated to the female connector depicting the cover and secondary lock.

### DETAILED DESCRIPTION OF THE INVENTION

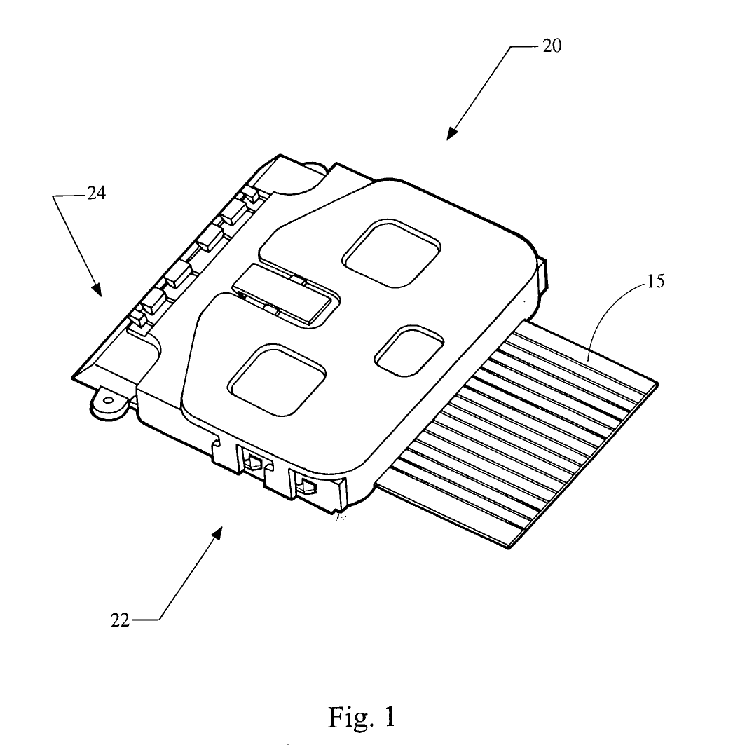

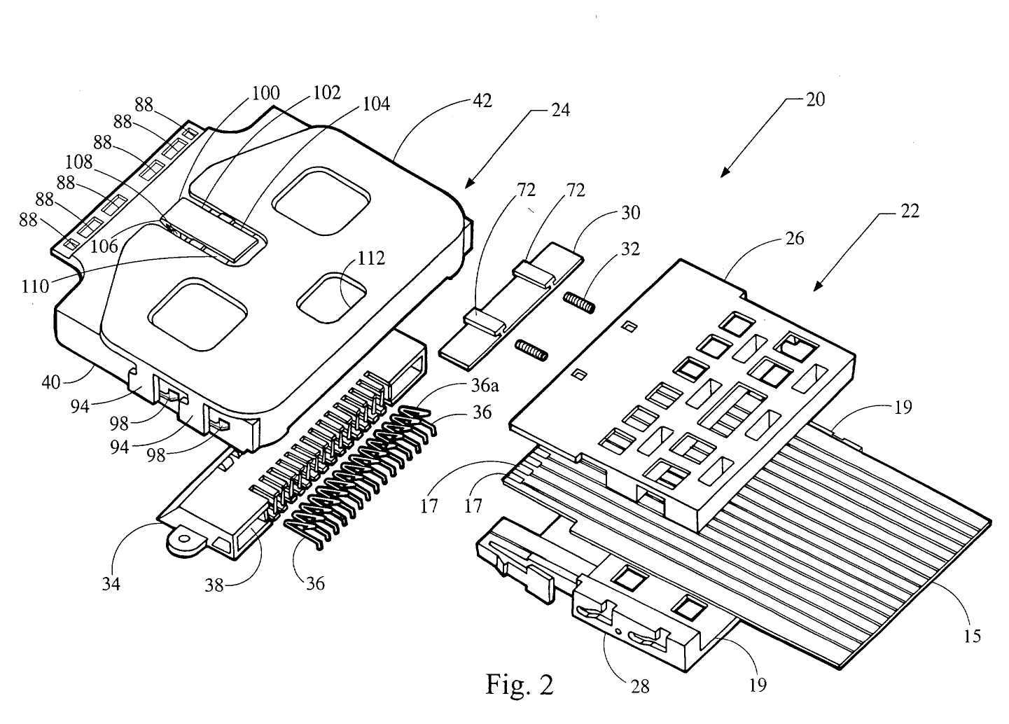

Turning now to the figures, FIGS. 1 and 2 depict an embodiment of a connector 20 for flatwire 15 constructed in accordance with the teachings of the present invention. The connector 20 generally comprises a male connector 22 and a female connector 24. When a male and female connectors, 22, 24 are mated, as shown in FIG. 1, an electrical connection is formed between the flatwire 15 and an electronic component (not shown) connected to the female connector 24. The electronic component attached to the female connector 24 can take many forms, such as a printed circuit board, a flexible circuit board, or another flatwire segment such as the segment 15 depicted in FIG. 1.

The female connector 24 generally includes a female housing 34 which is structured to receive the male connector housing 26, 28. The housing components 26, 28, 34 are preferably constructed of a polymer, most preferably a polyester, so that various features of structures can be deflectable or deformable. The terminals 36 also provide electrical connection to an electronic component (not shown) attached to the female connector 24 and more particularly its housing 34.

The female connector 24 also preferably includes a cover 40 which is pivotally attached to the female connector housing 34. A locking member 42 is moveably connected to the cover 40. The cover 40 and locking member 42 are utilized to securely mate the male and female connectors 22, 24.

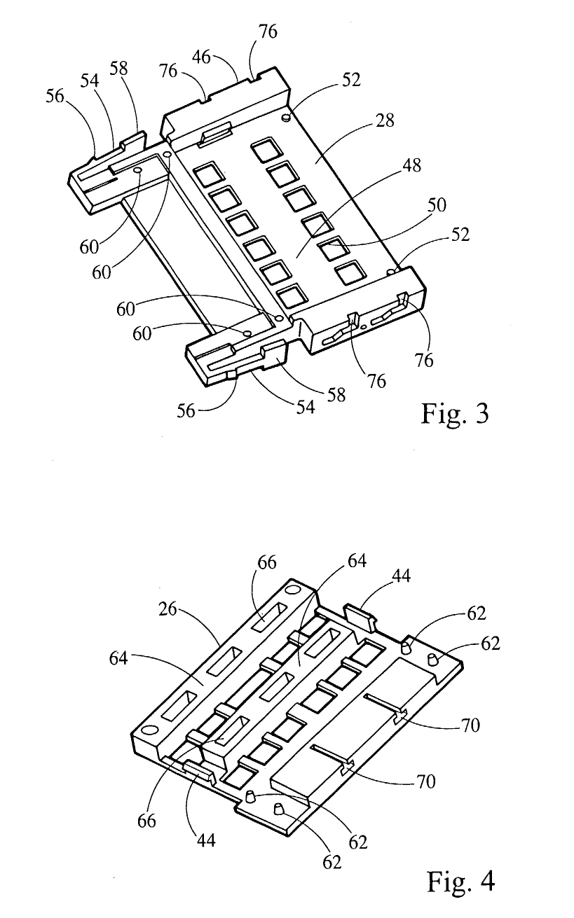

The male connector 22 will now be described with reference to FIGS. 3-5. A perspective view of the lower housing 28 is shown in FIG. 3 while a perspective view, taken from the bottom, of the upper housing 26, shown in FIG. 4. The upper housing 26 includes a pair of opposing tabs 44 which are deflectable and mate with opposing ridges 46 formed on the lower housing 28. The lower housing 28 includes a surface 48 having a number of apertures 50 formed therein. This surface 48 is sized to receive a bottom surface of the flatwire 15 and provide support thereto, while the apertures 50 allow the flatwire 15 to breathe. The lower housing 28 includes a pair of opposing pegs 52 which correspond with apertures 19 (FIG. 2) formed in the flatwire 15 at regular intervals. In this way, the flatwire 15, and more particularly its exposed conductive elements 17 may be properly positioned within the male connector 22.

Notably, the lower housing 28 includes a pair of opposing deflectable tabs 54 formed on the sides of the lower housing 28. The tabs 54 include ribs 56 which are structured to engage the female connector 24 and its housing 34. The tabs 54 also include pads 58 which allow a user to move the tabs 54 inwardly and release the ribs 56 in order to unmate or disconnect the male and female connectors 22, 24.

The lower housing 28 also includes opposing holes 60 for receiving pegs 62 formed on the underside of the upper housing 26 as shown in FIG. 4. Accordingly, the flaps 44 and pegs 62 of the upper housing 26 engage the ridges 46 and holes 60 on the lower housing 28 when the housings 26, 28 are attached. The pegs 62 may simply rest in the hole 60, but preferably are frictionally engaged therein, and most preferably heat staked or ultrasonically welded therein.

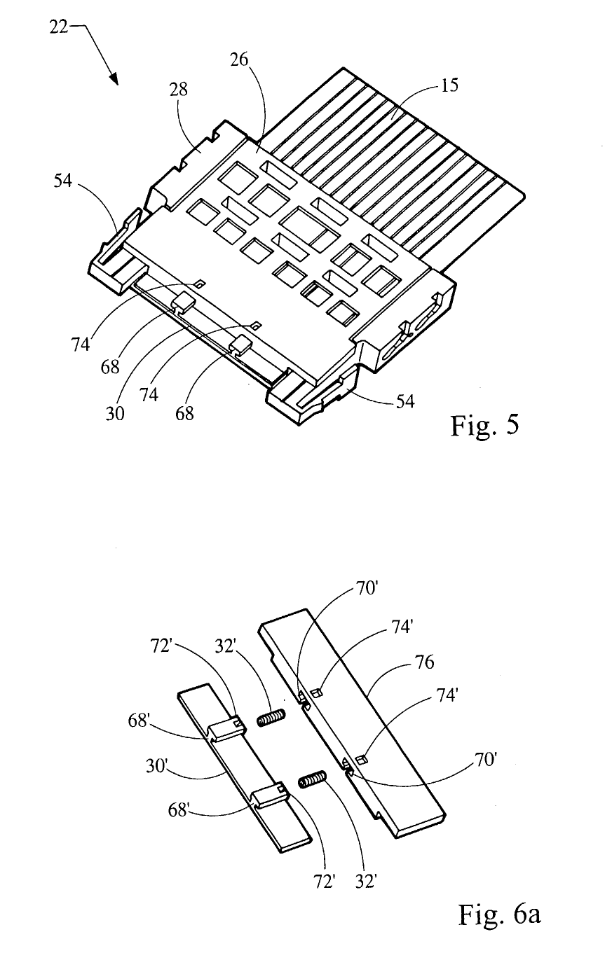

The upper housing 26 includes a surface 64 having a number of apertures 66 formed therein for engaging an upper surface of the flatwire 15 while allowing the flatwire 15 to breathe. The attachment of the upper housing 26 and lower housing 28 to form the male connector 22 is best seen in FIG. 5.

It will also be seen that the shield 30 forms a portion of the male connector 22 and is positioned between the upper and lower housings 26, 28. The shield 30 includes two flanges 68 which are generally T-shaped and correspond with slots 70 (FIG. 4) formed in the upper housing 26. The flanges 68 further include teeth 72 (FIG. 2) which engage notches 74 formed in the upper housing 26 in alignment with the slots 70. Springs 32 (FIG. 2) are positioned within the slots 70 to bias the shield 30 into an extended position protecting the conductive elements 17 of the flatwire 15. The shield 30 engages the female connector housing 34 when the male and female connectors 22, 24 are mated, thereby camming the shield 30 backwards into the upper housing 26 revealing the conductive elements 17 for electrical connection.

The lower housing 28 further includes at least one groove 76 formed in the side surface thereof. As will be described later herein, the grooves 76 work in conjunction with the locking element 42 to securely mate the male and female connectors 22, 24.

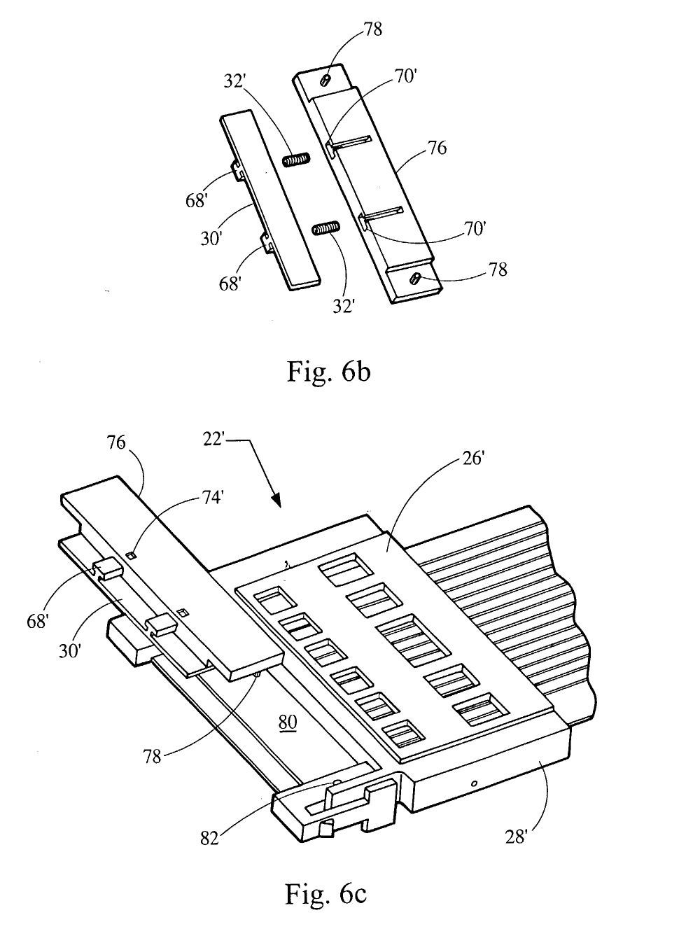

An alternate embodiment of the shield is male connector 22 is shown in FIGS. 6a-6c. The shield 30′ itself is substantially identical to that previously discussed, and includes flanges 68′ having teeth 72′ and being biased by springs 32′. However, a separate shield housing 77 is utilized. The shield housing 76 includes the slots 70′ and recesses 74′ for receiving and retaining the shield 30′. As best seen in FIG. 6b, the shield housing 77 includes pegs 78, which are used to connect the shield housing 77 to the lower housing 28n′ of the male connector 22′. As shown, the upper housing 26 is truncated as it does not include the structure for receiving the shield 30′. Rather, a recess 80 has been formed which includes holes 82 for receiving the pegs 78. Thus, in this embodiment, the shield 30′ may be added or removed as deemed appropriate by the user.

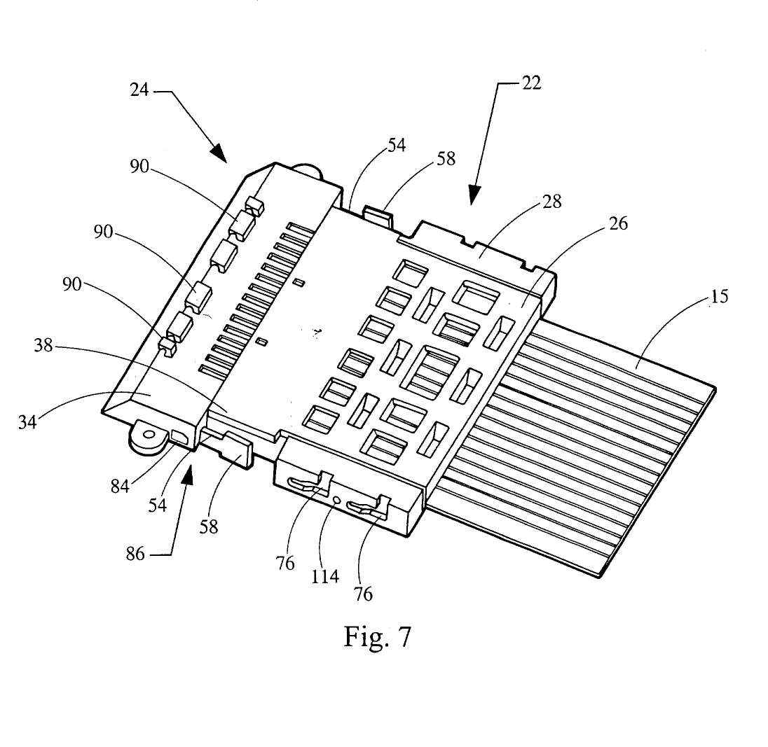

Turning now to FIG. 7, the male connector 22 is shown attached to the female connector 24, but without the cover 40 and its locking member 42 attached. The slot 38 of the female connector housing 34 receives the male connector 22. It can be seen that this includes the deflectable tabs 54 of the male connector 22. More specifically, the ribs 56 engage chambers 84 formed in the female connector housing 34. The chambers 84 are linked to the slot 38. Accordingly, a primary lock 86 is formed by the deflectable tab 54 which engaged the female connector housing 34. The resiliency of the deflectable tabs 54 is such that the connector 22 has a low mating force, i.e., insertion or friction force, in this interface area which permits easy mating and unmating of the male and female connectors 22, 24. Simply by depressing pads 58 on the deflectable tabs 54, the male connector 22 may be removed from the female connector 24.

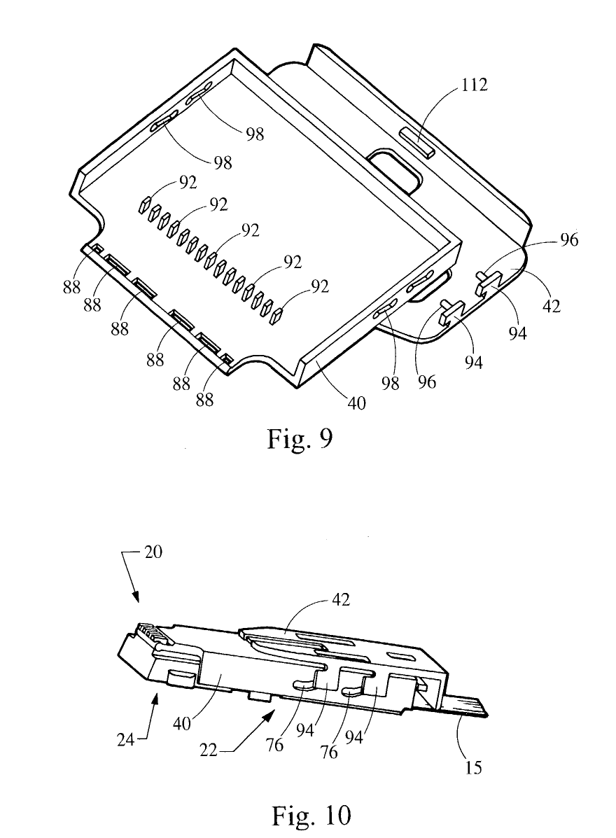

The cover 40 and its locking member 42 are best seen in FIGS. 2 and 9. The cover 40 includes a series of slots 88 which are sized and structured to correspond with a series of clips 90 formed on the female connector housing 34. The underside of the cover 40 also includes a number of pegs 92 which correspond with the terminals 36 and the exposed conductive elements 17. The pegs 92 are sized and positioned to engage an upper arm 36a of each terminal 36 and press it downwardly into contact with the exposed conductive elements 17. In this way, the cover 40 normal force downwardly on the terminals 36 pressing them into engagement with the conductive elements 17.

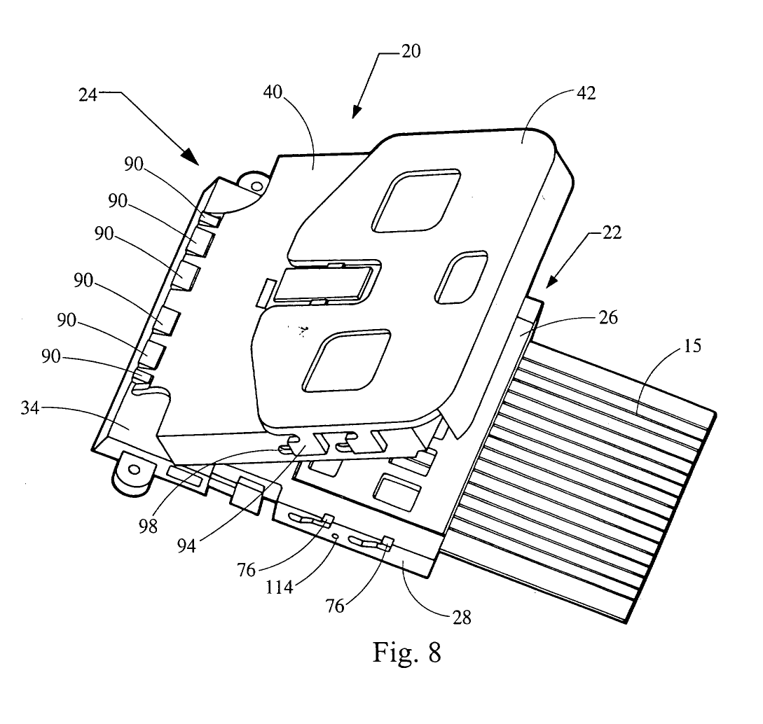

The locking member 42 is slideably attached to the cover 40 as shown in FIG. 8. The locking member 42 includes opposing legs 94 which have projections 96 extending inwardly therefrom. The projections 96 pass through slots 98 formed on a side surface of the cover 40. In this way, the locking member 42 is slideably attached to the cover 40.

The locking member 42 also includes a deflectable flap 100 having a first portion 102 and a second portion 104. The first portion 102 includes a ridge 106 which is structured to engage a notch 108 formed on the cover 40. The second portion 104 is structured to be positioned above a depression 110 formed in the cover 40 such that pressing downwardly on the second portion 104 removes the ridge 106 from the notch 108 allowing the locking member 42 to slide relative to the cover 40 as confined by the slots 98 and projections 96. Finally, the locking member 42 includes a tongue 112 which engages a recess (not shown) in the cover 40 when the deflectable flap 100 engages the cover 40.

FIG. 10 depicts the cover 40 in the closed position where cover 40 and its the pegs 92 press the terminals 36 into engagement with the exposed conductive elements 17 of the flatwire 15. In the position shown in FIG. 10, the cover 40 is frictionally engaged with the male connector 22, and specifically the lower housing by way of opposing bosses 114 formed on opposing side surfaces of the lower housing 28. The groove 76 formed in the lower housing 28 opens upwardly such that the projections 96 (FIG. 9) of the locking member may enter into the slots 76 as shown in FIG. 10. These grooves 76, which correspond with the slots 98 formed in the cover 40, extend both horizontally as well as vertically. In the initial unlocked position shown in FIG. 10, the projections 96 are positioned above their eventual location in a locked position. Stated another way, as the locking member 42 is slid to the left in FIG. 10, the projections 96 follow the contour of the grooves 76 and move vertically lower as they move horizontally. As previously noted, the locking member 42 is retained in the locked position by way of the deflectable flap 100 which engages a notch 108 on the cover 40. Additionally, the tongue 112 also engages the cover 40 as previously discussed.

Accordingly, it can be seen that by designing the slots 76 (as well as the corresponding slots 98 and the cover 40), the normal force with which the pegs 92 press on the terminals 36 and the exposed conductive elements 17 may be controlled. Thus, a predetermined normal force is set by sizing and shaping the grooves 76 formed in the male connector 22. A secondary lock is therefore formed defined by the slideable locking member 42 which includes a projection 96. The locking member 42 is operable to selectively position the projection 96 within the elongated grove 76 between a locked position and an unlocked position.

It can therefore be seen that the unique connector 20 of the present invention provides several useful features which suit the connector for the automotive environment. The male connector 22 has support surfaces which firmly engage the upper and lower surfaces of the flatwire to provide mechanical support thereto. Additionally, a spring-loaded shield is provided which automatically covers the exposed conductive elements of the flatwire protecting them from the environment. A primary lock is formed which allows simple mating of the male and female connectors while requiring a minimal mating or insertion force. The structure of the deflectable tabs on the male connector also provides easy detachment or unmating of the connector. Finally, the unique structure of the cover and its slidable locking member provide a simple to use, but secure and protective secondary locking feature to the connector.

The boss formed on the male connector allows the cover 40 to be positioned in a covered but unlocked position engaging the male connector. Operation of the locking member 42 securely connects the member to the cover, and thus in turn the female connector to the male connector. The unique structure of this locking member and the corresponding elongated groove on the male connector allows a predetermined normal force to be placed on the terminals and exposed conductive elements, thereby ensuring a reliable electric connection to the flatwire connected to the male connector.

The foregoing disclosure is the best mode devised by the inventors for practicing the invention. It is apparent, however, that automotive flatwire connectors incorporating modifications and variations may be conceivable to one skilled in the art of flatwire connectors suitable for use in harsh environments. Inasmuch as the foregoing disclosure is intended to enable one skilled in the pertinent art to practice the instant invention, it should not be construed to be limited thereby but should be construed to include such aforementioned variations and be limited only by the spirit and scope of the following claims:

1. A connector for flatwire having exposed conductive elements, the connector comprising:
a male connector having a male connector housing receiving said flatwire to present said conductive elements;
a female connector having a female connector housing structured to receive the male connector, the female connector including terminals positioned to contact said conductive elements for electrically connecting said flatwire to an electronic component;
a cover pivotally attached to the female connector housing, the cover operable between an open position and a closed position;
a primary lock defined by a deflectable tab formed on the male connector housing for engaging the female connector housing; and
a secondary lock defined by a locking member slidable relative to the male connector housing, the locking member having a projection positioned to extend into an elongated groove formed in the male connector housing, the locking member operable to selectively position the projection within the elongated groove between a locked position and an unlocked position.

2. The connector of claim 1, wherein the elongated groove extends vertically.

3. The connector of claim 2, wherein the locked position of the locking member and its projection is vertically below the unlocked position.

4. The connector of claim 1, wherein the cover includes pegs positioned to engage the terminals when the cover is in the closed position to provide a normal force on the terminals for secure contact with said conductive elements.

5. The connector of claim 4, wherein the elongated groove is positioned to provide a predetermined normal force on the terminals when the cover is in the closed position and the locking member is in the locked position.

6. The connector of claim 1, wherein the locking member is positioned on an outer surface of the cover, the cover including a slot sized and shaped to correspond to the elongated groove in the male connector housing, the slot receiving the projection.

7. The connector of claim 1, wherein the cover includes a boss for engaging the male connector housing in the closed position.

8. The connector of claim 1, wherein the secondary lock is further defined by a deflectable flap formed on the locking member and positioned to engage a recess formed in the cover when the locking member is in the locked position.

9. The connector of claim 8, wherein the deflectable flap includes a first portion and a second portion separated by a pivot line, the first portion including a rib for engaging the recess, a force on the second portion removing the rib from the recess then the locking member is in the locked position.

10. The connector of claim 1, wherein the cover includes a depression sized and positioned to receive a tongue formed on the locking member.

11. The connector of claim 1, wherein the locking member is slidably attached to the cover.

12. The connector of claim 1, wherein the cover and locking member are integrally formed.

13. The connector of claim 12, wherein the cover is pivotally and slidably attached to the female connector housing.

14. The connector of claim 1, wherein the primary lock is further defined by a pair of deflectable tabs formed on opposing side surfaces of the male connector housing.

15. The connector of claim 1, wherein the secondary lock is further defined by the locking member having a pair of projections on opposing side surfaces of the locking member, the pair of projections positioned to extend into corresponding pairs of elongated grooves formed in opposing side surfaces of the male connector housing.

16. A connector for flatwire having exposed conductive elements, the connector comprising:
a male connector having a housing receiving said flatware to present said conductive elements;
a female connector having a housing structured to receive the male connector, the female connector including terminals positioned to contact said conductive elements for electrically connecting said flatwire to an electronic component;
a primary lock defined by a deflectable tab formed on the male connector housing for engaging the female connector housing; and
a shield slidably disposed within the male connector housing, the shield operable between an extended position covering said conductive elements and a retracted position revealing said conductive elements.

17. The connector of claim 16, wherein the shield is biased to the extended position.

18. The connector of claim 16, wherein the female connector engages the shield and moves the shield between the extended and retracted positions when the male and female connectors are connected and disconnected, respectively.

19. The connector of claim 16, wherein the male connector housing includes an upper housing and a lower housing, said flatwire being located between the upper and lower housings.

20. The connector of claim 19, an upper surface of said flatwire includes said exposed conductors, wherein the shield is slidably attached to the upper housing for positioning above said exposed conductors in the extended position.

21. The connector of claim 19, wherein an upper surface of said flatwire is directly supported by the upper housing and a lower surface of said flatwire is directly supported by the lower housing.

22. The conductor of claim 16, wherein the male connector housing includes a slot sized and shaped to receive a flange formed on the shield.

23. The conductor of claim 16, further comprising a shield housing to which the shield is slidably attached, the shield housing being attached to the male connector housing.

24. A connector for flatwire having exposed conductive elements, the connector comprising:
a male connector having a housing receiving said flatwire to present said conductive elements;
a female connector having a housing structured to receive the male connector, the female connector including terminals positioned to contact said conductive elements for electrically connecting said flatwire to an electronic component;
a cover pivotally attached to the female connector housing, the cover operable between an open position and a closed position:
a primary lock defined by a deflectable tab formed on the male connector housing for engaging the female connector housing;
a secondary lock defined by a locking member slidable relative to the male connector housing, the locking member engaging the male connector housing in a locked position; and
a shield slidably disposed within the male connector housing, the shield operable between an extended position covering said conductive elements and a retracted position revealing said conductive elements.
